(19) United States
(12) Patent Application Publication
(10) Pub. No.: US 2024/0326277 A1
(43) Pub. Date: Oct. 3, 2024

(54) PUNCHING TOOL

(71) Applicant: Aptiv Technologies AG, Schaffhausen (CH)

(72) Inventor: Thomas Kiss, Oberwart (AT)

(21) Appl. No.: 18/604,877

(22) Filed: Mar. 14, 2024

(30) Foreign Application Priority Data
Mar. 29, 2023 (EP) 23165003.7

(51) Int. Cl. B26F 1/44

(52) U.S. Cl. CPC B26F 1/44; B26F 2001/4472

(57) ABSTRACT

The present disclosure is directed to a punching tool for punching out at least one beam element with both ends attached to the inside surface of an elongated through hole. The punching tool has an elongated shape with a punching end and a holding end. The punching end includes a front surface for being inserted into the elongated through hole first, and at least one cutting edge which is spaced apart from the front surface along the longitudinal axis of the punching tool and extends substantially transverse to the longitudinal axis. Further, the present disclosure is directed to a conductor receiving element for an electrical connector and a punching system including the punching tool and the conductor receiving element previously described.

### CROSS-REFERENCE TO RELATED APPLICATION

This application claims the benefit of and priority to European Patent Application No. 23165003.7 titled “Punching Tool” filed on Mar. 29, 2023, the contents of which are incorporated by reference herein.

### TECHNICAL FIELD

The present disclosure relates to a punching tool, a conductor receiving element, and a punching system including the punching tool and the conductor receiving element.

### BACKGROUND

For injection molded plastic components, it is often necessary to perform post-processing. For example, machining-related rework such as deburring or removal of sprues must be performed. However, various cases exist where post-processing must be performed to achieve a desired functionality of the injection molded component.

For example, conductor receiving elements for electrical connectors are known to have a plurality of elongated through holes to receive electrical conductors such as cables and/or terminals. Regularly, at least some of these through holes are at least partially blocked by a blocking element, so that no electrical conductor can be passed through until the blocking element has been removed. With the aid of a corresponding punching tool, the blocking element can be removed in order to adapt the corresponding through hole so that an electrical conductor can be fed through. This makes it possible to customize the electrical connector using the conductor receiving element. For example, a conductor receiving element can be adapted to different numbers of conductors depending on how many blocking elements have been removed. For example, eight blocking elements can be removed from a conductor receiving element with twelve blocked through holes to provide an eight-pole electrical connector. To prevent the cable channel following a blocked through hole from being exposed and for example moisture from penetrating into the electrical connector, the blocking elements are each regularly connected to a corresponding sealing pin which protrudes out of the through hole, for example to close a hole in a collective sealing.

The known punching tools and/or conductor receiving elements have the disadvantages that residues regularly remain in the component when the blocking elements are removed (see FIG. 12), damage to the through holes occurs in particular because of the punching tool, and/or a high punching force is required.

Thus, it is an object of the present disclosure to provide a punching tool, a conductor receiving element, and a punching system including the punching tool and the conductor receiving element that overcome the aforementioned drawbacks at least partially.

### SUMMARY

This object is achieved, at least partly, by a punching tool, a conductor receiving element, and a punching system including the punching tool and the conductor receiving element, as defined in the independent claims. Further aspects of the present disclosure are defined in the dependent claims.

In particular, the object is achieved by a punching tool for punching out at least one beam element with both ends attached to the inside surface of an elongated through hole, wherein the punching tool has an elongated shape with a punching end and a holding end. The punching end includes a front surface for being inserted into the elongated through hole first, and at least one cutting edge which is spaced apart from the front surface along the longitudinal axis of the punching tool and extends substantially transverse to the longitudinal axis.

The punching tool may be configured for punching polymer materials. Moreover, the punching tool may be adapted to be used without a die. Further, the punching tool may be integrally formed, whereas it is understood that the punching tool may also include separate parts being assembled. Preferably the punching tool is made of a metallic material such as steel, as this allows for longer durability.

Further, the punching end may be referred to as the end of the punching tool which punches the respective material/element. The holding end may be configured to be manually held and/or to be mounted within a respective punching system.

The front surface is preferably substantially perpendicular to the longitudinal axis of the punching tool. This allows elements to be reliably pressed out of through holes and, in particular, avoids jamming. The front surface may include more than one individual surface. Exemplarily, the front surface may be divided by a groove and/or a recess into at least two separate surfaces which lie in the same plane.

The at least one cutting edge may be also referred to as the at least one punching edge. The surfaces of the punching tool defining the at least one cutting edge preferably include an angle which lies in the range from 45° to 90°, preferably from 60° to 90°, further preferably from 80° to 90° and most preferably from 85° to 90°.

By the at least one cutting edge being spaced apart from the front surface along the longitudinal axis of the punching tool and extending substantially transverse to the longitudinal axis a damage to the through hole because of the punching tool can be avoided. This is as first the front surface is inserted into the elongated through hole so that the punching tool is already at least partially guided when the at least one cutting edge is inserted. Hence an accidental cutting of the through hole by the at least one cutting edge can be reliably avoided.

Optionally the minimum distance between the front surface and the at least one cutting edge lies in a range from 0.2 mm to 0.8 mm, preferably from 0.3 mm to 0.7 mm, and further preferably from 0.4 mm to 0.6 mm. These minimum distances have proven to be advantageous in that they allow for a sufficient guiding of the punching tool while at the same time avoiding an excessive length of the punching tool.

The at least one cutting edge may be adjacent to a peripheral surface of the punching tool. The peripheral surface may represent a guiding surface of the punching tool which allows for a guided sliding in the elongated through hole. By the at least one cutting edge being adjacent to the peripheral surface an element being attached to the through hole in which the punching tool is inserted can be separated directly at the point of attachment. Thereby a bending and uncontrolled breaking can be avoided. Thus, residues in the respective through hole can be avoided or at least reduced.

The at least one cutting edge may be inclined relative to the longitudinal axis of the punching tool, wherein preferably the inclination angle between the at least one cutting edge and the longitudinal axis lies in a range from 91° to 103°, preferably from 93° to 100°, and further preferably from 94° to 97°. It is to be noted that those ranges do not exclude that the at least one cutting edge extends substantially transverse to the longitudinal axis. By the at least one cutting edge being inclined relative to the longitudinal axis of the punching tool a cutting can be facilitated as a shear movement is favored.

The punching end may include a recess being formed into the front surface along the longitudinal axis of the punching tool, wherein preferably the at least one cutting edge forms part of the recess. The recess preferably tapers from the front surface to the at least one cutting edge. The recess can ensure that an element to be removed is first received in the punching end and stabilized therein before it is separated by the at least one trailing cutting edge. Moreover, by the recess tapering from the front surface to the at least one cutting edge the element to be removed can be particularly reliably received in the recess and guided to the cutting edge. The recess may have a variety of geometries, as set out in the following.

The recess may have a T-shape, or an X-shape as seen in a direction from the punching end to the holding end. The T-shape allows to receive and cut out two beam elements which are connected to form a T-shape. Further, the X-shape allows to receive and cut out two beam elements which intersect to form an X-shape.

The punching tool may include a flex portion arranged between the punching end and the holding end, wherein in the flex portion the cross-sectional area of the punching tool is reduced compared to portions of the punching tool being adjacent to the flex portion, wherein preferably in the flex portion the cross-sectional area continuously decreases to a minimum. The flex portion can increase flexibility between the two ends of the punching tool. Consequently, the transmission of bending loads through the punching tool is at least reduced. This means that if the punching tool has already been inserted into a through hole, a displacement of the holding end relative to the through hole and transverse to the longitudinal direction can be prevented from causing the punching end to tilt and thereby damaging the through hole. In summary, a more reliable punching can be achieved.

The peripheral edge of the front surface may be rounded and/or beveled, wherein the peripheral edge is preferably substantially perpendicular to the longitudinal axis of the punching tool. It is understood that if the front surface is separated into two surfaces as mentioned above, the peripheral edge of the front surface can also be separated.

The punching tool may include at least two, particularly at least three, and further particularly at least four, cutting edges configured as the at least one cutting edge described herein. As a result, more complex components, which are fastened with several attachment points in a through hole, can be reliably removed. Preferably at least two of the cutting edges are arranged opposite to each other and are axially spaced apart from each other along the longitudinal axis. Thereby can be achieved that the element to be removed is subjected to at least two shearing operations at separate times. This allows that an even more reliable punching can be achieved.

Further, the above object is also achieved by a conductor receiving element for an electrical connector, wherein the conductor receiving element includes a plurality of elongated through holes, wherein at least one through hole is at least partially blocked; a first beam element with a first end and a second end, wherein the first end and the second end are attached to the inside surface of the at least one through hole, and a sealing pin for sealing a hole of a collective sealing, wherein the sealing pin is attached to the first beam element and extends out of the at least one through hole.

Preferably, through the at least one through hole being at least partially blocked no electrical conductor can be passed through until the first beam element has not been removed. With the aid of the punching tool described herein the first beam element and optionally the second beam element as mentioned in the following may be removed to adapt the at least one through hole so that an electrical conductor can be fed through.

By using the conductor receiving element it is possible to customize an electrical connector. Exemplarily, a conductor receiving element with multiple blocked through holes can be adapted to a different number of conductors depending on how many blocking elements are removed. For example, eight first beam elements can be removed from a conductor receiving element with twelve through holes being blocked by respective first beam elements to provide an eight-pole electrical connector.

The sealing pin may allow to prevent a cable channel following a through hole being blocked from being exposed and for example moisture from penetrating into the respective electrical connector.

Further, the conductor receiving element may be integrally formed with the first beam element. Exemplarily by means of injection molding.

The first beam element is preferably linear. This has been shown to facilitate removal. However, it is also conceivable that the first beam element is curved and/or angled. Further, the first beam element may have a substantially rectangular cross-section. “Substantially” in this context means that the edges may be rounded, as it is exemplarily required for injection molded parts. Preferably, the first beam element is distinctly identifiable between the first end and the second end at any position. This is also the case if the first beam element intersects another beam element or has a kink.

It is understood that of the plurality of elongated through holes, multiple or even all through holes may be at least partially blocked.

The first beam element and the sealing pin preferably do not intersect. Exemplarily, if the sealing pin has a cylindrical shape and the first beam element substantially has the shape of a rectangular cuboid, then a base area of the cylindrical shape may be attached to the outside of the rectangular cuboid shape of the first beam element. Particularly, the rectangular cuboid shape and the cylindrical shape may be integrally formed. However, the rectangular cuboid shape may not protrude through the cylindrical shape. In particular, the first beam element and the sealing pin preferably do not define a section volume. The first beam element and the sealing pin not intersecting with each other has at least two advantages. First, this configuration allows that the manufacture of the conductor receiving element is simplified. The fact that the first beam element and the sealing pin do not intersect means that there is a separation plane, which allows for simpler design of the mold cores for injection molding. Secondly, this configuration has proven to be advantageous in that it promotes more reliable separation of the first beam element compared to cases where the first beam element and the sealing pin intersect.

The conductor receiving element may include a second beam element with a first end and a second end, wherein the first beam element and the second beam element intersect, wherein the first end and the second end of the second beam element are attached to the inside surface of the at least one through hole. Preferably, the first beam element and the second beam element form an X-shape. This shape has proven to be particularly stable and at the same time casy to remove.

Alternatively, the conductor receiving element may include a second beam element with a first end and a second end, wherein the first end of the second beam element is attached to the inside surface of the at least one through hole and the second end of the second beam element is attached to the first beam element. Preferably, the first beam element and the second beam element form a T-shape. This shape has proven to be particularly easy to remove and at the same time allows for a sufficient level of stability.

Furthermore, it is understood that the second beam element may be configured as the first beam element.

The sealing pin may be attached to the first beam element and the second beam element, wherein the first beam element and the second beam element preferably do not intersect with the sealing pin. Exemplarily, if the sealing pin has a cylindrical shape and the beam elements substantially each have the shape of a rectangular cuboid, then a base area of the cylindrical shape may be attached to the outside of the rectangular cuboid shape of the beam elements. As above, the rectangular cuboid shapes and the cylindrical shape may be integrally formed, whereas the rectangular cuboid shapes may not protrude through the cylindrical shape. In particular, the beam elements and the sealing pin preferably do not define a section volume. It has shown that by the sealing pin being attached to the first beam element and the second beam element the stability and/or stiffness of the sealing pin within the respective through hole may be enhanced.

Moreover, the above object is also achieved by a punching system including at least one punching tool as described herein, and the conductor receiving element as described herein, wherein the at least one punching tool and the conductor receiving element are configured such that the at least one punching tool is slidingly guided in the at least one through hole which is at least partially blocked. Exemplarily, the peripheral surface of the punching tool may be configured to be slidingly guided by the inside surface of the at least one through hole.

The punching system preferably further includes a receptacle in which the conductor receiving element can be floatingly supported. This allows inaccuracies regarding the positioning of the punching tool relative to the conductor receiving element to be compensated. This makes it possible to achieve precise guidance of the punching tool in the corresponding through hole and to ensure that any tolerance-related offset of the punching tool relative to the conductor receiving element does not lead to damage.

Further, the punching system is configured such that the height of the first and/or second beam element measured along the at least one through hole being at least partially blocked is larger than the distance by which the at least one cutting edge is spaced apart from the front surface along the longitudinal axis of the punching tool. Hence, a contact of the punching tool with the sealing pin can be avoided which ensures a reliable punching operation.

### BRIEF DESCRIPTION OF THE DRAWINGS

The present invention is now described, by way of example with reference to the accompanying drawings, in which:

FIG. 1 shows an isometric view of a punching tool according to some embodiments.

FIG. 2 shows a detailed isometric view of the punching end of the punching tool according to some embodiments.

FIG. 3 shows a detail side view of the punching end of the punching tool according to some embodiments.

FIG. 4 shows a top view of a conductor receiving element according to some embodiments.

FIG. 5 shows a detailed view of the conductor receiving element of FIG. 4 according to some embodiments.

FIG. 6 shows a detailed isometric view of the conductor receiving element of the conductor receiving element of FIG. 4 according to some embodiments.

FIG. 7 shows an isometric view of the conductor receiving element of the conductor receiving element of FIG. 4 according to some embodiments.

FIG. 8 shows an isometric view of a punching system according to some embodiments.

FIG. 9 shows a detail of the receptacle of the punching system of FIG. 8 according to some embodiments.

FIG. 10 shows an isometric view of the punching system prior to punching according to some embodiments.

FIG. 11 an isometric view of the punching system during punching according to some embodiments.

FIG. 12 shows a conductor receiving element according to the prior art.

### DETAILED DESCRIPTION

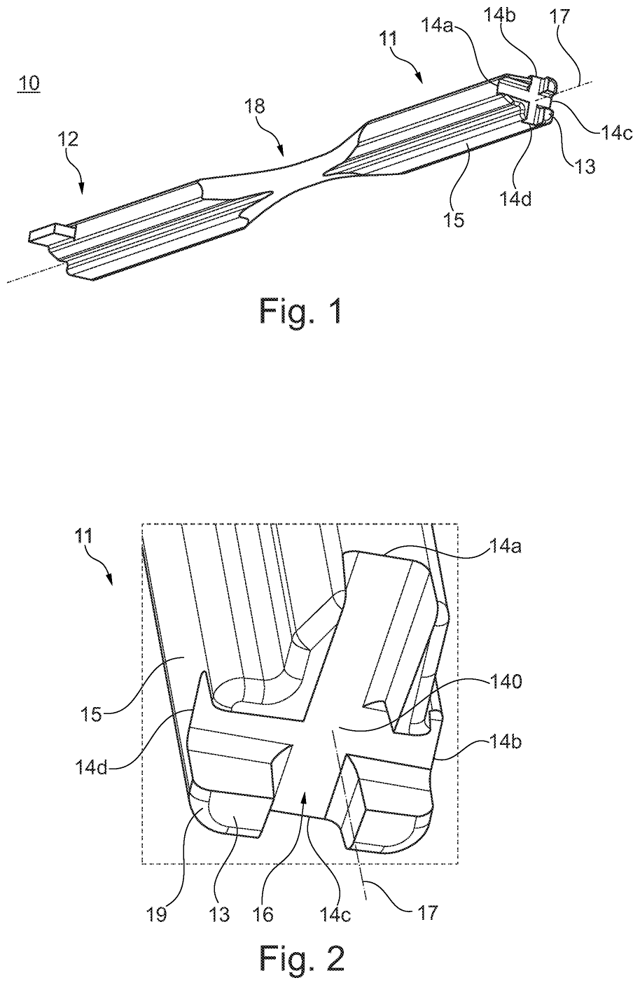

FIG. 1 shows a punching tool 10 for punching out at least one beam element 22 with both ends 23, 24 attached to the inside surface of an elongated through hole 21c (see FIG. 4). The punching tool 10 has an elongated shape with a punching end 11 and a holding end 12. The punching tool 10 includes a flex portion 18 arranged between the punching end 11 and the holding end 12, wherein in the flex portion 18 the cross-sectional area of the punching tool 10 is reduced compared to portions of the punching tool 10 being adjacent to the flex portion 18. Particularly, in the flex portion 18 the cross-sectional area continuously decreases to a minimum.

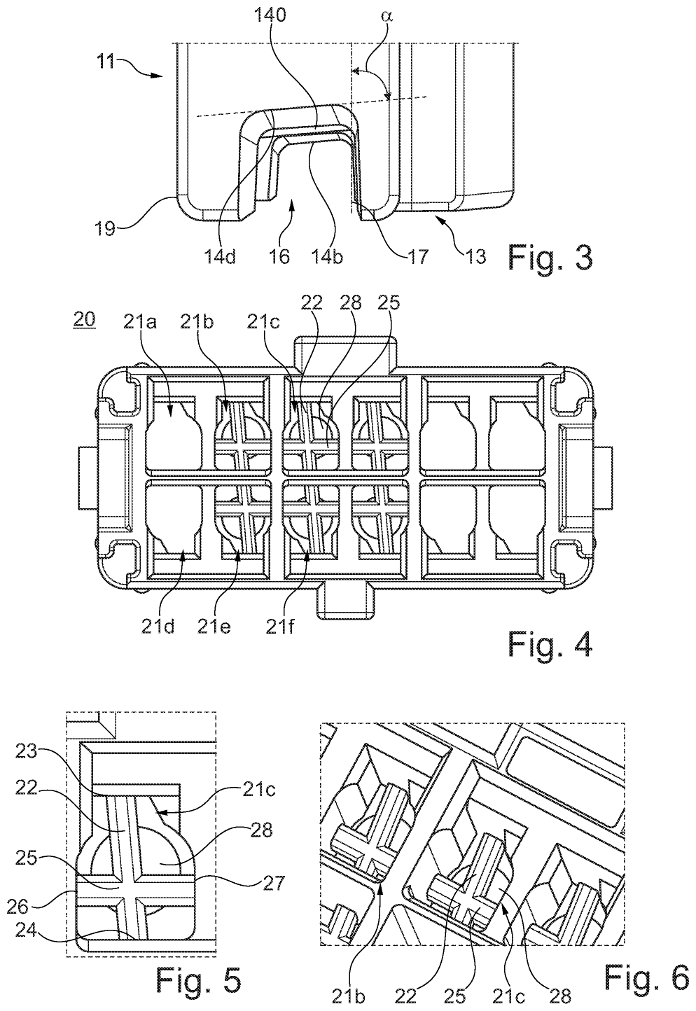

The punching end 11 is depicted in detail in FIGS. 2 and 3. The punching end 11 includes a front surface 13 for being inserted into the elongated through hole first. From FIG. 2 particularly it is understood that the front surface 13 is segmented into four surfaces which lie in one plane. Further, the punching end 11 includes four cutting edges 14a, 14b, 14c, 14d which are spaced apart from the front surface 13 along the longitudinal axis 17 of the punching tool 10 and extend substantially transverse to the longitudinal axis 17.

As depicted in FIG. 2, the cutting edges 14a, 14b, 14c, 14d are adjacent to a peripheral surface 15 of the punching tool 10. Moreover, the punching end 11 includes a recess 16 being formed into the front surface 13 along the longitudinal axis 17 of the punching tool 10, wherein the cutting edges 14a, 14b, 14c, 14d form part of the recess 16. The recess 16 has an X-shape as seen in a direction from the punching end 11 to the holding end 12. Further, the recess 16 tapers from the front surface 13 to the four cutting edges 14a, 14b, 14c, 14d. Even further, the peripheral edge 19 of the front surface 13 is rounded, wherein the rounded peripheral edge 19 is substantially perpendicular to the longitudinal axis 17 of the punching tool 10.

As depicted in detail in FIG. 3 the cutting edges 14b and 14d are inclined relative to the longitudinal axis 17 of the punching tool 10, wherein the inclination angle α between the cutting edges 14b, 14d and the longitudinal axis 17 lies in a range from 94° to 97°. Further, as also depicted in FIG. 3, the cutting edges 14b, 14d are arranged opposite to each other and are axially spaced apart from each other along the longitudinal axis 17. Moreover, all cutting edges 14a, 14b, 14c, 14d are connected by a substantially planar surface 140.

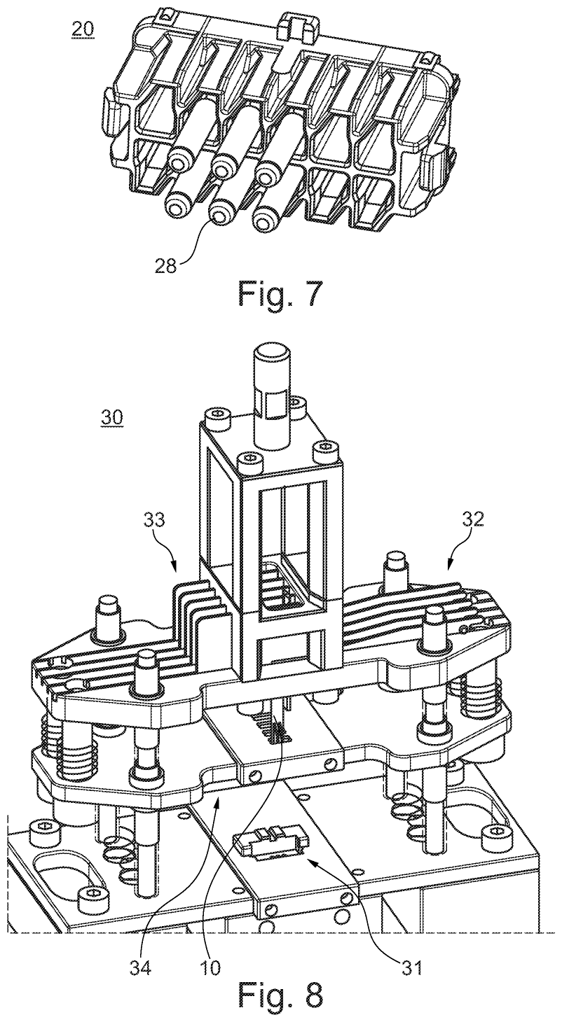

FIGS. 4 to 7 show a conductor receiving element 20 for an electrical connector. The conductor receiving element 20 includes a plurality of elongated through holes 21a, 21b, 21c, 21d, 21e, 21f. The through holes 21b, 21c, 21e, 21f are at least partially blocked. The conductor receiving element 20 further includes a first beam element 22 with a first end 23 and a second end 24, wherein the first end 23 and the second end 24 are attached to the inside surface of the blocked through hole 21c. It is understood that the through holes 21b, 21e, 21f are blocked similarly. Moreover, the conductor receiving element 20 includes a sealing pin 28 for scaling a hole of a collective sealing, wherein the sealing pin 28 is attached to the first beam element 22 and extends out of the through hole 21c. The other sealing pins are not numbered for the sake of simplicity.

Further, the conductor receiving element 20 includes a second beam element 25 with a first end 26 and a second end 27, wherein the first beam element 22 and the second beam element 25 intersect, wherein the first end 26 and the second end 27 of the second beam element 25 are attached to the inside surface of the at least one through hole 21c. Thereby the sealing pin 28 is attached to the first beam element 22 and the second beam element 25, wherein the first beam element 22 and the second beam element 25 do not intersect with the sealing pin 28.

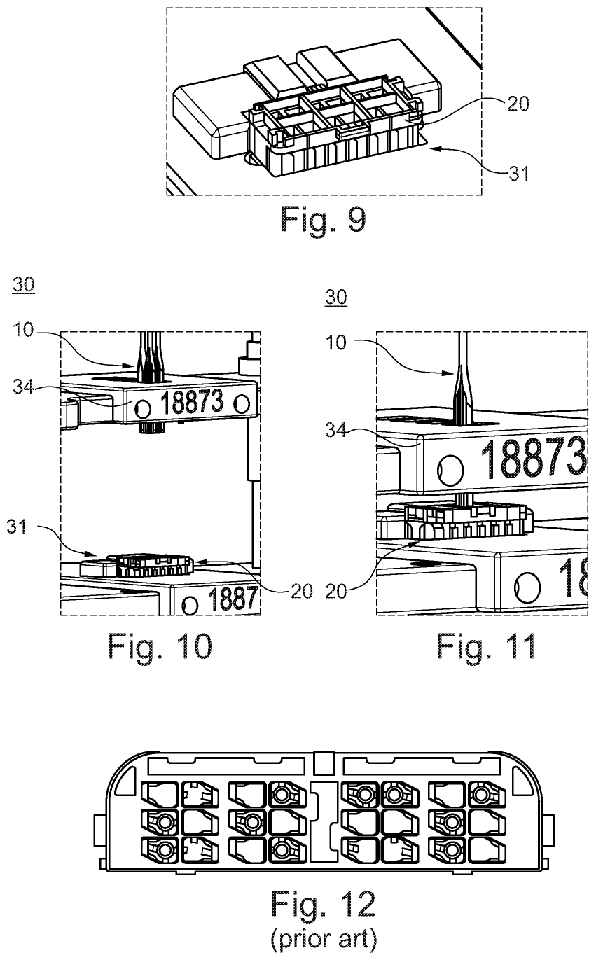

FIGS. 8 to 11 show a punching system 30 and details thereof. The punching system 30 includes at least one punching tool 10 as described in the foregoing, and the conductor receiving element 20 as described in the foregoing, whereas in FIG. 8 the conductor receiving element 20 is hidden. As shown in FIGS. 10 and 11, the at least one punching tool 10 and the conductor receiving element 20 are configured such that the at least one punching tool 10 is slidingly guided in the at least one through hole which is at least partially blocked. Further, as depicted in detail in FIG. 9, the punching system 30 includes a receptacle 31 in which the conductor receiving element 20 can be floatingly supported.

The punching system 30 of FIG. 8 further includes lift plates 32 and fixing plates 33. The lift plates 32 allow to lift punching tools 10 which are not required for a punching operation because exemplarily only one through hole of a plurality of through holes needs to be punched free. When lifted by the lift plates 32 the respective punching tools 10 may be fixed in the upper position relative to the receptacle 31 by means of the fixing plates 33. Thus, only the punching tools 10 which are intended to perform a punching operation move down towards the receptacle 31 within the punching tool guiding 34 when the punching is performed (see FIGS. 10 and 11).

Further, even though not explicitly depicted in the FIGS., the punching system 30 may include blow nozzles which blow against the punching end 11 of the at least one punching tool 10 after punching operation. Thus, residues at the punching end 11 may be reliably removed. Moreover, a suction chamber may be provided below the receptacle 31 which serves to suck away the punched out components.

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. A punching tool configured for punching out at least one beam element with both ends attached to an inside surface of an elongated through hole, wherein the punching tool has an elongated shape with a punching end and a holding end and wherein the punching end comprises:
a front surface for being inserted into the elongated through hole first, and
at least one cutting edge which is spaced apart from the front surface along a longitudinal axis of the punching tool and extends substantially transverse to the longitudinal axis.

2. The punching tool according claim 1, wherein the at least one cutting edge is adjacent to a peripheral surface of the punching tool.

3. The punching tool according claim 1, wherein the at least one cutting edge is inclined relative to the longitudinal axis of the punching tool and wherein an inclination angle between the at least one cutting edge and the longitudinal axis lies in a range from 91° to 103°.

4. The punching tool according claim 3, wherein the longitudinal axis lies in a range from 93° to 100°.

5. The punching tool according claim 4, wherein the longitudinal axis lies in a range from 94° to 97°.

6. The punching tool according claim 1, wherein the punching end comprises a recess formed into the front surface along the longitudinal axis of the punching tool.

7. The punching tool according claim 6, wherein preferably the at least one cutting edge forms part of the recess.

8. The punching tool according claim 7, wherein the recess tapers from the front surface to the at least one cutting edge.

9. The punching tool according to claim 6, wherein the recess has a T-shape or an X-shape as seen in a direction from the punching end to the holding end.

10. The punching tool according claim 1, wherein the punching tool comprises a flex portion arranged between the punching end and the holding end and wherein a cross-sectional area in the flex portion of the punching tool is reduced compared to portions of the punching tool adjacent to the flex portion and wherein the cross-sectional area in the flex portion continuously decreases to a minimum.

11. The punching tool according claim 1, wherein a peripheral edge of the front surface is rounded and/or beveled and wherein a peripheral edge is substantially perpendicular to the longitudinal axis of the punching tool.

12. The punching tool according claim 1, wherein the punching tool comprises two instances of the at least one cutting edge.

13. The punching tool according claim 12 wherein the two instances of the at least one cutting edge are arranged opposite to each other and are axially spaced apart from each other along the longitudinal axis.

14. A conductor receiving element for an electrical connector, wherein the conductor receiving element comprises:
a plurality of elongated through holes, wherein at least one through hole is at least partially blocked;
a first beam element with a first end and a second end, wherein the first end and the second end are attached to an inside surface of the at least one through hole, and
a sealing pin for sealing a hole of a collective sealing, wherein the sealing pin is attached to the first beam element and extends out of the at least one through hole.

15. The conductor receiving element according to claim 14, wherein the first beam element and the sealing pin do not intersect.

16. The conductor receiving element according to claim 14, wherein the conductor receiving element comprises a second beam element with a first end and a second end, wherein the first beam element and the second beam element intersect, and wherein the first end and the second end of the second beam element are attached to the inside surface of the at least one through hole.

17. The conductor receiving element according to claim 16, wherein the sealing pin is attached to the first beam element and the second beam element and wherein the first beam element and the second beam element do not intersect with the sealing pin.

18. The conductor receiving element according to claim 14, wherein the conductor receiving element comprises a second beam element with a first end and a second end and wherein the first end of the second beam element is attached to the inside surface of the at least one through hole and the second end of the second beam element is attached to the first beam element.

19. A punching system, comprising:
at least one punching tool configured for punching out at least one beam element with both ends attached to an inside surface of an elongated through hole, wherein the punching tool has an elongated shape with a punching end and a holding end, the punching end including:
a front surface for being inserted into the elongated through hole first, and
at least one cutting edge which is spaced apart from the front surface along a longitudinal axis of the punching tool and extends substantially transverse to the longitudinal axis; and the punching system further comprising:
a conductor receiving element, having:
a plurality of elongated through holes, wherein at least one through hole is at least partially blocked,
a first beam element with a first end and a second end, wherein the first end and the second end are attached to the inside surface of the at least one through hole, and
a sealing pin for sealing a hole of a collective sealing, wherein the sealing pin is attached to the first beam element and extends out of the at least one through hole, wherein the at least one punching tool and the conductor receiving element are configured such that the at least one punching tool is slidingly guided in the at least one through hole which is at least partially blocked.

20. The punching system according to claim 19, wherein the punching system further comprises a receptacle in which the conductor receiving element is floatingly supported.
